(19) United States
(12) Patent Application Publication
(10) Pub. No.: US 2014/0161001 A1
(43) Pub. Date: Jun. 12, 2014

(54) Resource Allocation for Flexible TDD Configuration

(71) Applicant: BROADCOM CORPORATION, Irvine, CA (US)

(72) Inventors: Chunyan GAO, Beijing (CN); Erlin ZENG, Beijing (CN); Jing HAN, Beijing (CN); Wei HONG, Beijing (CN)

(73) Assignee: BROADCOM CORPORATION, Irvine, CA (US)

(21) Appl. No.: 13/964,172

(22) Filed: Aug. 12, 2013

Related U.S. Application Data
(63) Continuation of application No. PCT/CN2011/070915, filed on Feb. 10, 2011.

(51) Int. Cl. H04L 1/18; H04J 3/02

(52) U.S. Cl. CPC H04L 1/18; H04J 3/02
USPC 370/280

(57) ABSTRACT

There is determined a first uplink-downlink configuration for subframes in a frame, which in various examples is fixed or dynamically allocated. A second uplink-downlink configuration is semi-statically allocated such as in system information. When mapping automatic repeat request signaling for a first user equipment which is dynamically allocated an uplink-downlink configuration, at least some downlink subframes mapped by the second uplink-downlink configuration are excluded by the mapping. In one example, UL resources mapped from a first group DL subframes are indexed according to the second configuration, and then UL resources mapped from a second group of DL subframes are indexed according to the first configuration, and the excluded DL subframes are within the first group and excluded from the second group and the automatic repeat request signaling is in an uplink resource mapped from the second group.

### TECHNICAL FIELD

The exemplary and non-limiting embodiments of this invention relate generally to wireless communication systems, methods, devices and computer programs and, more specifically, relate to mapping between downlink subframes and uplink subframes and control channel elements therein, such as for purposes of automatic repeat request signaling.

### BACKGROUND

The following abbreviations that may be found in the specification and/or the drawing figures are defined as follows:

3GPP third generation partnership project

CCE control channel element

CRC cyclic redundancy check

DL downlink

eNB node B/base station in an E-UTRAN system

E-UTRAN evolved UTRAN (LTE)

HARQ hybrid automatic repeat request

LTE long term evolution

LTE-A long term evolution advanced

PDCCH physical downlink control channel

PCFICH physical control format indicator channel

PHICH physical HARQ indicator channel

PUCCH physical uplink control channel

PUSCH physical uplink shared channel

RRC radio resource control

TDD time division duplex

UE user equipment

UL uplink

UTRAN universal terrestrial radio access network

The LTE-Advanced wireless system aims to provide enhanced services by means of higher data rates and lower latency with reduced cost. One benefit of deploying the LTE TDD system is to enable asymmetric UL-DL allocations in a frame; since typically more data is sent DL there can be a higher number of DL subframes in a frame to accommodate that greater data volume. But this makes mapping the ACK/NACK for the DL frame more complex, since more DL than UL subframes means the ACK/NACK for more than one DL subframe must map to the same UL subframe in which the ACK/NACK is sent to the network.

In LTE TDD the asymmetric resource allocation is realized by providing seven different semi-statically configured UL-DL subframe configurations for a given frame, as shown at FIG. 1 which is reproduced from Table 10.1-1 of 3GPP TS 36.213 v9.0.1 (2009 December). These allocations can provide between 40% and 90% DL subframes, and in conventional practice the UL-DL configuration in use is informed to the UE (and changed) only via system information on the broadcast channel. The UL-DL configuration is only allocated semi-statically and so cannot adapt to the instantaneous traffic situation. This is an inefficient resource utilization, particularly in cells with a small number of users where the traffic situation typically changes more frequently.

To address this inefficiency, what is termed a ‘flexible TDD configuration’ has been proposed as a study item for LTE-A Release 11. Two proposals for such a flexible TTD configuration were submitted at the 3GPP TSG-RAN Meeting #50 (Istanbul, Turkey; Dec. 7-10, 2010) and are set forth at document RP-101265 by Ericsson and ST Ericsson entitled “New study item proposal for UL-DL Flexibility and Interference Management in LTE TDD”; and document RP-101241 by CATT entitled “New Study Item Proposal: DL-UL Interference Management for TDD EUTRA”.

As with asymmetric UL-DL configuration itself, there are challenges to overcome before any implementation may be considered viable. For flexible TDD allocation one such challenge is how to map feedback signaling and HARQ timing between the UL subframes and CCEs which carry that feedback signaling and the DL subframes to which that feedback signaling is reporting upon.

Since the Release 11 deployment will have to maintain some backward compatibility with pre-Release 11 UEs (legacy UEs), and to more clearly detail the environment for the exemplary embodiments of the invention detailed below, first consider those seven existing Release 10 TDD UL-DL configurations noted above and reproduced at FIG. 1. Specifically for LTE, the UE sends its ACK/NACK in UL subframe n for DL subframe n-k, where kεK:{k₀, k₁ . . . k_{M-1}} and the value for k is given at the intersection of the current UL-DL configuration (row) and the UL subframe n (column). The UE adds the value k to the DL subframe in which it receives data to find the subframe n in which the UE is to send its corresponding ACK/NACK, and the eNB subtracts the value k from the UL subframe n in which the eNB received the ACK/NACK to know which DL subframe, and which data, is being ACK'd/NACK'd,

In the current LTE specification, the PUCCH ACK/NACK resources are defined as a function of M, which is the size of the DL association set as shown in FIG. 1 and above. Unlike the mapping example above, at FIG. 1 there are asymmetric UL-DL configurations in which multiple DL subframes map to one UL subframe. For example, for UL-DL configuration #2, UL subframe n=2 is associated with four DL subframes, (n-8), (n-7), (n-4), and (n-6). One PUCCH resource will be reserved for each CCE index in those four DL subframes, and the reserved PUCCH resources are interleaved to minimize the inefficiency in “overbooking”. More specifically, for ACK/NACK bundling or ACK/NACK multiplexing with association set size the PUCCH resource for ACK/NACK feedback in subframe #n is determined by the index of first CCE used for sending the DL grant according to the following equation taken from section 10.1 of 3GPP TS 36.213 v9.0.1 (2009 December):

n_{PUGGH}⁽¹⁾=CCE_{Index}+N_{PHGGH}⁽¹⁾;
where, CCE_{Index}=(M−m−1)×Nₚ+m×Nₚ₋₁+n_{CCE}, and
p is selected from {0, 1, 2, 3} such that Nₚ≦n_{CCE,i}<Nₚ₊₁,
Nₚ=max{0,└[N_{RB}^{DL}×(N_{sc}^{RB}×p−4)]/36┘}, n_{CCE,j} is the number of the first CCE used for transmission of the corresponding PDCCH in subframe n−kᵢ, and N_{PUCCH}⁽¹⁾ is configured by higher layers.

But if there is a different understanding on the TDD configuration, either between different UEs or between a UE and the eNB, there clearly can be a PUCCH resource collision or a detection error at the eNB. Such different understanding may arise from different UEs have different TDD configurations, which is inevitable if only the Release 11 UEs are to be capable of flexible TDD allocations. It may also arise from signaling error, by example if a UE does not correctly detect signaling which indicates for the UE its new flexible TDD configuration,

FIGS. 2A-B illustrate the PUCCH resource collision problem in which the Release 11 UE has been flexibly (dynamically) allocated UL-DL configuration 2 and the legacy UE has been semi-statically (via broadcast system information) allocated UL-DL configuration 0. Both UEs send an ACK or NACK in UL subframe n=2, which by FIG. 1 maps for the legacy UE (configuration 0) to DL subframe n-6 and for the Release 11 UE (configuration 2) maps to DL subframes (n-8), (n-7), (n-6) and (n-4).

FIG. 2B gives an example of the CCE indexing according to the conventional rules above (taken from TS 36,213, section 10). In this example, CCEs in the (n-6)^{th} subframes for the legacy UEs (top row of FIG. 2B) and CCEs in the (n-7)^{th} and (n-8)^{th} subframes for the Release 11 UEs (second row of FIG. 2B) may get the same index and map to same PUCCH resource. This is a PUCCH collision.

Two straightforward solutions to this collision are seen by the inventors as sub-optimal. Simply configuring a different PUCCH resource offset for the Release 11 UEs to avoid such collisions is highly inefficient because multiplexing between Release 11 and legacy UEs in the PUCCH region is not possible. Configuring the subframes (n-4) and (n-8) as UL subframes to avoid the collision over-reserves the PUCCH and results in a discontinuous PUSCH resource. The opposite solution is reserving PUCCH subframes (n-4) and (n-8) for only flexible TDD allocation use is also an over-reservation, but in this case would likely increase the peak-to-average power ratio PAPR and would impose an undesirable scheduling restriction on the PUSCH at least concerning the legacy UEs. The description below is seen to be a more elegant and optimal solution to the above collision problem.

### SUMMARY

In a first exemplary embodiment of the invention there is an apparatus comprising at least one processor and at least one memory storing a computer program. In this embodiment the at least one memory with the computer program is configured with the at least one processor to cause the apparatus to at least: determine a first uplink-downlink configuration for subframes in a frame and a second uplink-downlink configuration for subframes in a frame, in which the second uplink-downlink configuration is semi-statically allocated; and exclude at least some downlink subframes mapped by the second uplink-downlink configuration when mapping automatic repeat request signaling for a first user equipment which is dynamically allocated an uplink-downlink configuration.

In a second exemplary embodiment of the invention there is a method comprising: determining a first uplink-downlink configuration for subframes in a frame and a second uplink-downlink configuration for subframes in a frame, in which the second uplink-downlink configuration is semi-statically allocated; and excluding at least some downlink subframes mapped by the second uplink-downlink configuration when mapping automatic repeat request signaling for a first user equipment which is dynamically allocated an uplink-downlink configuration.

In a third exemplary embodiment of the invention there is a computer readable memory storing a computer program, in which the computer program comprises: code for determining a first uplink-downlink configuration for subframes in a frame and a second uplink-downlink configuration for subframes in a frame, in which the second uplink-downlink configuration is semi-statically allocated; and code for excluding at least some downlink subframes mapped by the second uplink-downlink configuration when mapping automatic repeat request signaling for a first user equipment which is dynamically allocated an uplink-downlink configuration.

These and other embodiments and aspects are detailed below with particularity.

### BRIEF DESCRIPTION OF THE DRAWINGS

FIG. 1 shows the possible UL-DL subframe configurations for a frame, reproduced from Table 10.1-1 of 3GPP TS 36.213 v9.0.1 (2009 December).

FIG. 2A illustrates PUCCH resource collision at UL subframe n-6 resulting when a first UE is flexibly allocated UL-DL configuration 2 (top row) and a second UE is semi-statically allocated UL-DL configuration 0 (bottom row).

FIG. 2B shows the conventional CCE indexing which results in the collision at FIG. 2A, in which the HARQ from the second UE uses configuration 0 (top row) and from the first UE uses configuration 2 (bottom row).

FIG. 3 are mapping diagrams for three examples which illustrate CCE indexing when mapping to a PUCCH resource according to a first exemplary embodiment of the invention.

FIG. 4 are mapping diagrams for two examples which illustrate CCE indexing when mapping to a PUCCH resource according to a second exemplary embodiment of the invention.

FIG. 5 are mapping diagrams for five examples which illustrate CCE indexing when mapping to a PUCCH resource according to a third exemplary embodiment of the invention.

FIG. 6 is a mapping diagram for one example illustrating CCE indexing when mapping to a PUCCH resource according to a fourth exemplary embodiment of the invention.

FIG. 7 is a logic flow diagram that illustrates the operation of a method, and a result of execution of computer program instructions embodied on a computer readable memory, in accordance with the exemplary embodiments of this invention.

FIG. 8 is a simplified block diagram of the UE in communication with a wireless network illustrated as an eNB and a serving gateway SGW, which are exemplary electronic devices suitable for use in practicing the exemplary embodiments of this invention.

### DETAILED DESCRIPTION

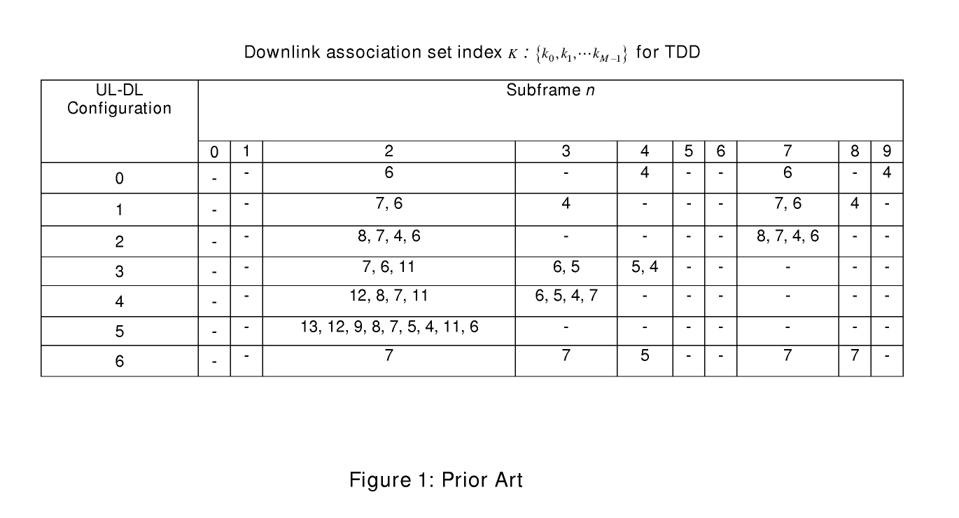

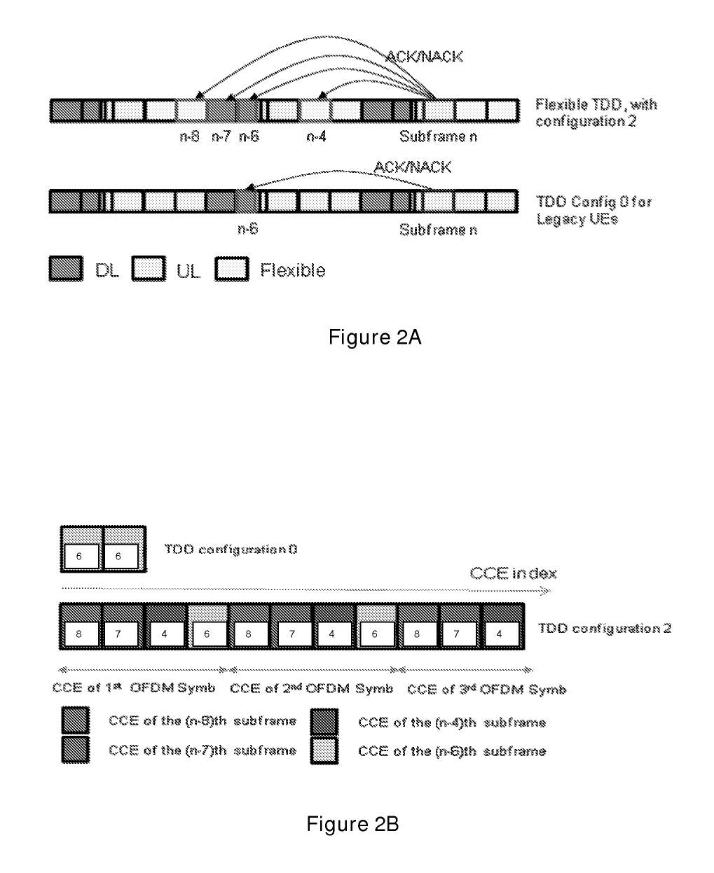

Exemplary embodiments of these teachings provide new PUCCH resource allocation schemes for UEs supporting flexible TDD, which avoids at least some of the problems detailed in the background section above. While the examples detailed below are in the context of the LTE-Advanced TDD system and specifically re-use the LTE Release 10 UL-DL configurations reproduced at FIG. 1, these are only for simplicity of explanation and the broader aspects of these teachings are not limited to either of those specifics.

Firstly, consider that the TDD subframes can be divided into fixed subframes and dynamic/flexible subframes in order to balance among complexity and flexibility.

Examining the seven TDD configurations of LTE Release 10 at FIG. 1, the link directions of subframes 0, 1, 2, 5, and 6 are fixed (except that in some cases subframe #6 can be a special subframe including a downlink pilot timeslot DwPTS region) for the seven TDD configurations while link directions of other subframes are changing.

Secondly, in the background section was noted two possibilities for driving PUCCH collisions. Collisions due to signaling error can be avoided by restricting the ACK/NACK feedback in a fixed subframe, thereby rendering the feedback mapping independent of the TDD configuration for the Release 11 (flexible TDD allocated) UE. The cost of this is a bit increased delay in the HARQ feedback signaling.

No decisions have been made in the 3GPP development of Release 11 concerning HARQ timing for flexible TDD UL-DL configurations, and so the examples herein follow two broad directions for the PUCCH resource allocation. The examples below of the exemplary embodiments of these teachings are divided into these two broad directions, discussed as case 1 and case 2. Both enable efficient ACK/NACK feedback for a flexible TDD system as well as enable coexistence of legacy UEs and new (Release 11) UEs.

Case 1 concerns the general approach in which the ACK/NACK feedback for the new UE (which supports flexible UL-DL configuration) is restricted to follow the ACK/NACK feedback timing as specified for the existing TDD UL-DL configuration #2 (or alternatively TDD UL-DL configuration #5). This means that regardless of what is the flexibly configured UL-DL for the new UE, the ACK/NACK feedback mapping is done using UL-DL configuration #2. The reason that UL-DL configuration #2 is chosen (or alternatively #5) is that these have the greatest number of DL subframes, which means the DL association set is at its maximum size.

Case 2 concerns the general approach in which the ACK/NACK feedback for the new UE (which supports flexible UL-DL configuration) follows the exact pattern for the flexibly configured UL-DL configuration. This is possible when both the eNB and the new UE have the same understanding of which is the flexible TDD UL-DL configuration that is allocated.

From the UE's perspective there is at least one DL subframe from which it needs to map to an associated UL subframe in which that UE sends its HARQ signaling. The network may have to map in reverse more than one UL subframe in which it receives HARQ signaling from multiple UEs to the corresponding DL subframes which the network sent. The examples below assume that there is an initial TDD configuration which is the TDD UL-DL configuration that is broadcast in the system information and which is used conventionally by the legacy UEs in the cell.

If we consider that this initial uplink-downlink configuration which is semi-statically allocated is a second UL-DL configuration, then as will be seen in the examples below there is also first UL-DL configuration which is used to map the HARQ signaling, but at least some of the DL subframes mapped by the second configuration are excluded from the conventional form of that mapping. The HARQ signaling for the legacy or second UE will be conventional, using the second UL-DL configuration which is semi-statically signaled. But for the new or first UE, the HARQ signaling is mapped using the first DL-UL configuration and excluding all or some of those DL subframes which are mapped by the second UL-DL configuration.

For case 1 mapping of the HARQ timing is therefore independent of the flexible TDD UL-DL configuration which is dynamically allocated to the first UE, since in this case the first UL-DL configuration is fixed: in an embodiment it is UL-DL configuration #2 (or alternatively #5) of FIG. 1 regardless of which configuration is dynamically allocated to that first UE. Mapping HARQ signaling for a given DL subframe far the first UE under case 1 remains the same regardless of the dynamically allocated configuration, which may be considered a third UL-DL configuration and which may or may not be the same as the first UL-DL configuration in any given instant. For case 2 mapping of the HARQ timing is dependent on the flexible TDD UL-DL configuration which is dynamically allocated to the first UE since in that case the first UL-DL configuration is the dynamically allocated UL-DL configuration. Mapping HARQ signaling for a given DL subframe for the first UE under case 2 changes depending upon the dynamically allocated configuration. For both case 1 and case 2, mapping HARQ signaling for a given DL subframe for the second (legacy) UE remains unchanged and conventional for Release 10 according to the examples below.

In the following examples of the various PUCCH resource allocation schemes, it is assumed that the first (new) UE is configured with ACK/NACK bundling or ACK/NACK multiplexing with M=1 where M is the size of the DL association set. This assumption is not limiting and these examples can readily be extended to the situation where ACK/NACK multiplexing with M greater than 1 is used.

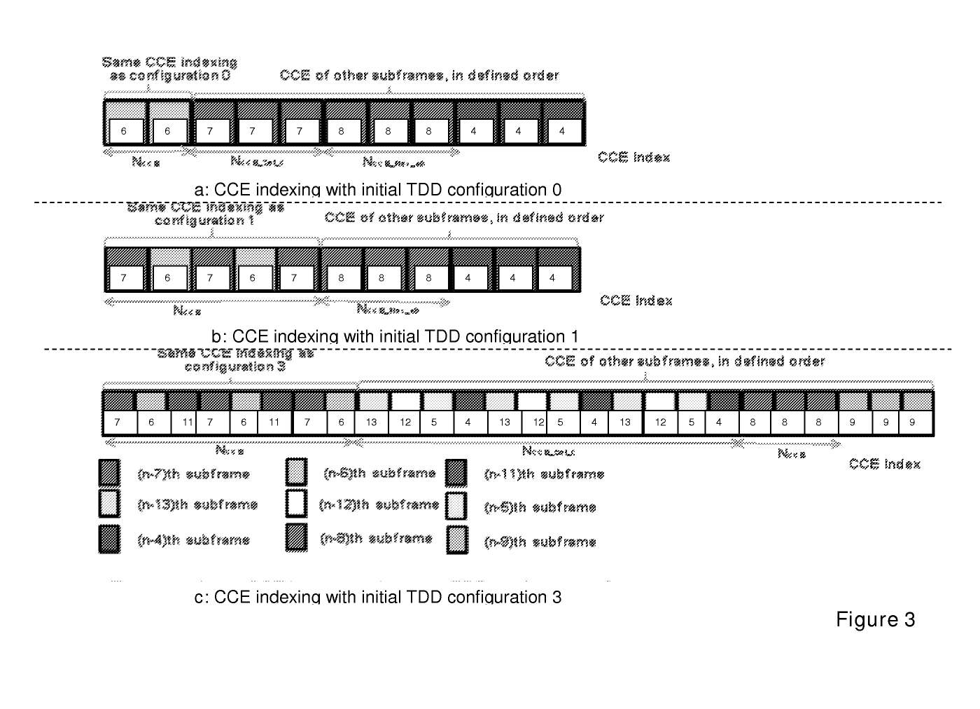

FIG. 3 illustrates PUCCH resource mapping in three distinct examples of a first exemplary embodiment under case 1, where HARQ timing for the first UE is independent of the UL-DL configuration which is dynamically allocated to the first UE. Under the general approach of ease 1, the ACK/NACK feedback is restricted to fixed UL subframes and the first UL-DL configuration itself is fixed, by example as configuration #2 or alternatively #5 of FIG. 1. In the FIG. 3 examples the PUCCH resource mapping is implicit in the signaling which dynamically allocates a UL-DL configuration to the first UE.

According to the FIG. 3 examples a, b and c, the PUCCH resources in which the ACK/NACK is found by the following procedure.

First, a DL association set is determined based on the conventional allocations (FIG. 1). If we assume that the fixed DL/UL configuration is #2 (or #5), then denote the relevant DL subframes for that configuration as set A, and the DL association set from the initial TDD configuration (also at FIG. 1) are denoted as set B. Denote n as the UL subframe as in FIG. 1. For example 3a the first/fixed configuration is #2 and the initial/second configuration is #0 meaning set A={n-8, n-7, n-4, n-6} and set B={n-6}; for example 3b the first/fixed configuration is also #2 and the initial/second configuration is #1 meaning set A={n-8, n-7, n-4, n-6} and set B={n-7, n-6}; and for example 3c the alternate first/fixed configuration #5 is assumed and the initial/second configuration is #3 meaning set A={n-13, n-12, n-9, n-8, n-7, n-5, n-4, n-11, n-6} and set B={n-7, n-6, n-11}.

Second, the DL subframes within set A are divided into two groups. The first group contains the DL subframes/special subframes in set B, which is the DL association set determined by the second/initial TDD configuration. The second group contains all other DL subframes in set A, For example 3a, group 1=set B={n-6} and group 2=set A-set B={n-8, n-7, n-4}; for example 3b, group 1=set B={n-7, n-6} and group 2=set A-set B={n-8, n-4}; and for example 3c, group 1=set B={n-7, n-6, n-11} and group 2=set A-set B={n-13, n-12, n-9, n-8, n-5, n-4} where {n-13, n-12, n-5, n-4} are fixed DL subframes and indexed first, followed by flexible subframes {n-8, n-9}.

Third, the PUCCH resource for the first group subframes are indexed first in the same way as for the second/initial TDD configuration, namely,

n_{PUCCH}⁽¹⁾=(M−m−1)×Nₚ+m×Nₚ₋₁+n_{CCE}+B_{PUCCH}⁽¹⁾.

Fourth, the PUCCH resource for the second group subframes are indexed in the following way:
i. Fixed DL subframes in the second group form a DL association set C, the PUCCH resource for them is determined by:

n_{PUCCH}⁽¹⁾=(M_{C}−m−1)×Nₚ+m×Nₚ₋₁+n_{CCE}+N_{CCE}+N_{PUCCH}⁽¹⁾,
where M_{C} is the number of DL subframes in set C and N_{CCE} is the total number of CCEs in the first group subframes. The variable m assumes the UE is configured for ACK/NACK bundling; if configured for ACK/NACK multiplexing the conventional i is in place of m for the above equation;
ii. PUCCH for flexible subframes 4 or 9 are indexed as follows if available

(FIG. 3 shows subframes 4 in examples a and b and subframes 4 and 9 at example c);

$${n}_{PUCCH}^{( 1 )} = {n}_{CCE} + {N}_{CCE} + {N}_{{CCE}_{{set}_{C}}} + {N}_{PUCCH}^{( 1 )} ,$$

where N_{CCE}_{_{—}}ₛₑₜ_{_{—}}_{C} is the number of CCEs in set C subframes, else it is set to 0 if set C is empty;
iii. PUCCH for flexible subframe 3 or 8 are indexed as follows if available (FIG. 3 shows subframes 8 only in each of the examples a, b and c);

$${n}_{PUCCH}^{( 1 )} = {n}_{CCE} + {N}_{CCE} + {N}_{{CCE}_{{set}_{C}}} + {N}_{{CCE}_{{Flex}_{49}}} + {N}_{PUCCH}^{( 1 )} ,$$

where N_{CCE}_{_{—}}_{Flex}_{_{—}}₄₉ is the number of CCEs in flexible subframe 4 or 9, else if no flexible subframe 4 or 9 is in the second group it is set to be 0.

As shown in the examples at FIG. 3, the DL subframes which need to be fed back in the same UL subframe are divided into 2 groups. The first group consists of the DL subframe/special subframes which need to be fed back in same UL subframe n according to the second/initial TDD configuration indicated in system information. For DL subframes in this group, their CCEs are interleaved and indexed in the same way as that for the second/initial TDD configuration as is conventional for Release 10 when used to map to their PUCCH resource. This makes it backward compatible with the legacy UE's operation.

All other DL subframes/special subframes which need to be fed back in the same UL subframe n according to TDD configuration 2 (or if the second/initial TDD configuration has a 10 ms period as in UL-DL configuration #3, then use TDD configuration #5 as the first configuration) form the second group. For the fixed DL subframes in the second group, their CCEs are also interleaved as is conventional for Release 10 before mapping to their PUCCH resource. The interleaving for CCEs in the fixed subframe in the second group is done in the same way as is conventional for Release 10 for this first TDD configuration #2 (or #5), with the CCEs of DL subframes in the first group and the flexible subframes deleted. Then the CCEs of the flexible subframes are indexed following that of the fixed DL subframe in the second group when mapping to their PUCCH resource.

If there are multiple flexible DL subframes in the second group, the PUCCH resources for the flexible subframes n-4 and/or n-9 are indexed first, then the PUCCH resources for flexible subframes n-3 and/or n-8 are indexed. This is due to the consideration that subframe n-4 or n-9 is set as DL subframes in more TDD configurations than subframes n-3 or n-8. That is, since subframe n-3 or n-8 is more likely to be UL subframes, then it is better to put their PUCCH resource adjacent to the PUSCH so as to avoid a discontinuous PUSCH resource.

For example, at example 3a, according to TDD configuration #2, DL subframes {n-8, n-7, n-4, n-6} need to be fed back in UL subframe n, and they form the set A, and among them {n-6} is in set B and the PUCCH for it is indexed firstly. Since according to the initial TDD configuration #0 it needs to be fed back in the same UL subframe, then {n-8, n-7, n-4} are in the second group. Then n-7 is a fixed DL subframe and its PUCCH resources are indexed following subframe n-6, while n-8 and n-4 are flexible subframes and indexed following subframe n-7.

The first/new UE maps from the DL subframe in which it received data to the appropriate UL subframe n_{PUCCH}⁽¹⁾ in the second group as above. This mapping follows that of the first/fixed UL-DL configuration but as above it maps only to the second group of subframes, which for this first embodiment excludes all the DL subframes which are mapped by the second/initial UL-DL configuration. The network maps similarly but in reverse, from the UL subframe in which it received an ACK/NACK to the DL subframe associated with that ACK/NACK to know which data sent by the network is being ACK'd/NACK'd.

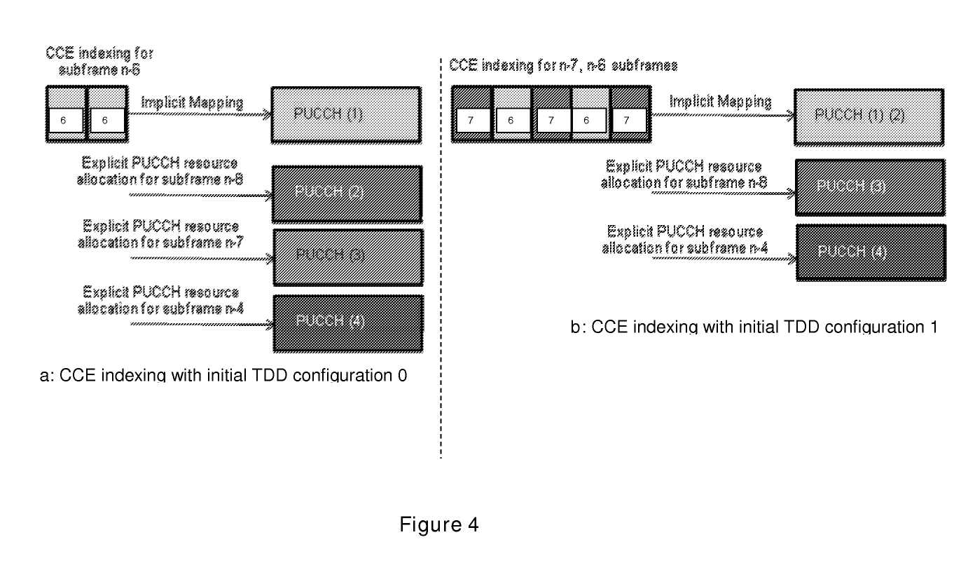

FIG. 4 illustrates PUCCH resource mapping in two distinct examples of a second exemplary embodiment under case 1, where again HARQ timing for the first UE is independent of the UL-DL configuration which is dynamically allocated to the first UE. Still under the general approach of case 1 the ACK/NACK feedback is restricted to fixed UL subframes (e.g., configuration #2 or #5).

Whereas for the first embodiment of FIG. 3 the PUCCH resource mapping was implicit in the signaling which dynamically allocated a UL-DL configuration to the first UE, for the second embodiment at FIG. 4 there is an implicit and an explicit hybrid PUCCH allocation. For this second embodiment the first group of DL subframes is the same as is detailed above for the first embodiment, but for this second embodiment the PUCCH resources for DL subframes within the second group are communicated by the eNB via some explicit signaling.

At FIG. 4 example a assumes that the second/initial TDD UL-DL configuration is 0, and example b assumes the second/initial TDD UL-DL configuration is 1, both those configurations being detailed at FIG. 1. As with the first example under case 1, mapping the HARQ signaling for the first/new UE (which is dynamically allocated its UL-DL configuration) excludes the DL subframes mapped by the second/initial UL-DL configuration, but in this case some but not necessarily all of the DL subframes mapped by the second/initial configuration are excluded. The second group of DL subframes in this second embodiment may not be identical to the second group under the first embodiment above. This is possible because in this second embodiment the explicit signaling enables the network to tailor it for current allocations for legacy UEs in the cell, so for example if the second/initial configuration is #1 but no data is currently sent DL to a UE in DL subframe n-7, then in this second embodiment it is possible for the network to allow that UL subframe n for ACK/NACK feedback from a new UE even though that UL subframe maps generically under UL-DL configuration #1. Below are two distinct but non-limiting ways for the network to signal this second group of UL subframes to that first/new UE.

In a first implementation of the second embodiment, the set of PUCCH resources associated with the DL subframes within the second group are assigned via higher layer signaling on a per UE basis. The second implementation of the second embodiment may be considered as two steps. First, multiple sets of PUCCH resources associated with the DL subframes within the second group are assigned via higher layer signaling on a per UE basis. Then the network dynamically indicates to the first/new UE which one among the sets will be used for the given UL subframe. In both implementations the first UE is left with a group of DL subframes which exclude at least some of those which map according to the second/initial UL-DL configuration since some UEs in the cell will be utilizing that configuration, but the DL subframes within the second set are adjustable by the network in this second embodiment on a per-UE basis, without having to change the second/initial configuration for the whole cell.

At FIG. 4, example a has UL subframe n=2 mapping from DL subframe n-6 as set forth in the mapping for second/initial subframe configuration 0, and the second group of DL subframes is signaled to the first/new UE so as to identify the second group of subframes as {n-8, n-7, n-4} which each map to different PUCCH resources. Example b at FIG. 4 has UL subframe n=2 mapping from DL subframes n-7 and n-6 as set forth in the mapping for second/initial subframe configuration #1, and the second group of DL subframes is signaled to the first/new UE so as to identify the second group of subframes as {n-8, n-4} which each map to different PUCCH resources than the {n-7, n-6} DL subframes. In each case collisions with the legacy UE mapping from the {n-6} or {n-7, n-6} DL subframes are avoided. The PUCCH resource for the first group of DL subframes is determined by implicit mapping as is conventional for Release 10 for the second/initial TDD configuration, while the PUCCH resources for the second group DL subframes are explicitly signaled.

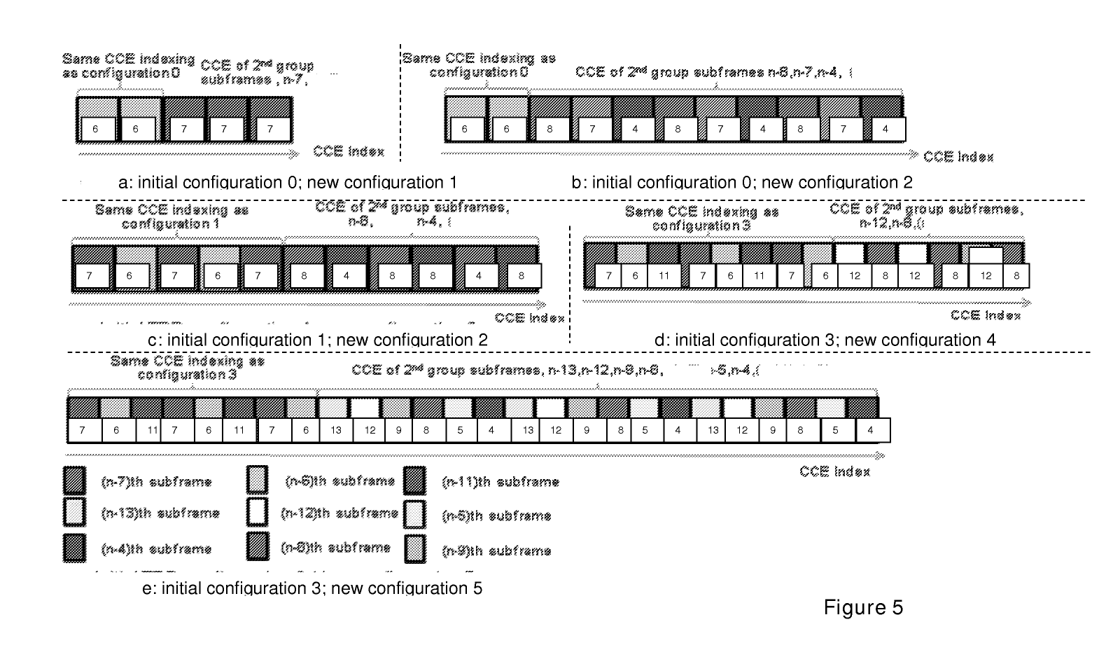

FIG. 5 illustrates PUCCH resource mapping in five distinct examples of a third exemplary embodiment which falls under case 2, where HARQ timing for the first UE is dependent on the UL-DL configuration which is dynamically allocated to the first UE. Under the general approach of case 2, the ACK/NACK feedback is not restricted to fixed UL subframes since the first UL-DL configuration is itself the one which is dynamically allocated to the first/new UE. Like FIG. 3, in the FIG. 5 examples the PUCCH resource mapping is implicit in the signaling which dynamically allocates a UL-DL configuration to the first UE.

According to the non-limiting FIG. 5 examples a, b, c, d and e, the PUCCH resources in which the ACK/NACK is found by the following procedure.

First, two DL subframe/special subframe groups are defined as follows, assuming UL subframe n is the one in which the mapped ACK/NACK is sent. These two groups do not necessarily have to be complementary to each other.
i. The first group contains the DL association set corresponding to the UL subframe according to the second/initial TDD configuration. For examples 5a and 5b the initial configuration is 0 and so the first group is {n-6}; for example 5c the initial configuration is 1 and so the first group is {n-7, n-6}; and for examples 5d and 5e the initial configuration is 3 and so the first group is {n-7, n-6, n-11}.
ii. The second group contains the DL subframes in DL association set corresponding to the UL subframe according to the first/flexible UL-DL configuration, but not in the first group. For example 5a the flexible configuration is 1 and so subtracting out its first group leaves the second group as {n-7}; for example 5b the flexible configuration is 2 and so subtracting out its first group leaves the second group as {n-8, n-7, n-4}; for example 5c the flexible configuration is also 2 and so subtracting out its first group leaves the second group as {n-8, n-4}; for example 5d the flexible configuration is 4 and so subtracting out its first group leaves the second group as {n-12, n-8}; and for example 5e the flexible configuration is 5 and so subtracting out its first group leaves the second group as {n-13, n-12, n-9, n-8, n-5, n-4}.

Second, the PUCCH resource for the first group subframes are indexed first in the same way as for the initial TDD configuration in Release 10,

n_{PUCCH}⁽¹⁾=(M−m−1)×Nₚ+m×Nₚ₋₁+n_{CCE}+B_{PUCCH}⁽¹⁾.

Third, the second group subframes form a DL association set C, and the PUCCH resources for them are indexed as follows:

n_{PUCCH}⁽¹⁾=(M_{C}−m−1)×Nₚ+m×Nₚ₋₁+n_{CCE}+N_{CCE}+N_{PUCCH}⁽¹⁾
where M_{C} is the number of DL subframes in the second group and N_{CCE} is the total number of CCEs in the first group subframes.

Restricting all the ACK/NACK feedback to fixed UL subframes as in the first and second embodiments has the advantage of being simpler, but it results in a large feedback size in one UL subframe, and a long HARQ delay. The third and fourth embodiments address those issues since the HARQ timing depends on the flexible TDD configuration itself and so the ACK/NACK feedback time follows from the dynamically configured TDD configuration. In these embodiments the link direction of the flexible subframe is already known, so there need not be any over-reservation for the flexible subframes and co-existence with legacy UEs is the key issue to address.

In the third and fourth embodiments the DL subframes which need to be fed back in the same UL subframe n are again divided into 2 groups. The first group consists of DL subframe/special subframes which need to be fed back in the same UL subframe n according to the second/initial TDD configuration indicated in system information. For DL subframes in this group, their CCEs are interleaved and indexed in the same way as is conventional for that second/initial TDD configuration in Release 10 when mapping to PUCCH resources. This resolves the backward compatibility issue in the same way as the first and second embodiments.

All other DL subframes/special subframes which need to be fed back in the same UL subframe n according to the first/flexible TDD configuration form the second group. In the third embodiment, for DL subframes in the second group, their CCEs are interleaved and indexed after the first group CCEs when mapping to PUCCH resources. For example, assuming CCEs in the first group are indexed from 0 to N_{CCE}−1, then the index of the CCEs in the second group will start from N_{CCE}. The interleaving for the subframe in the second group is done in the same way as is conventional for Release 10 for the second (flexible) TDD configuration, but with the DL subframes of the first group deleted. According to the fourth embodiment below the PUCCH resources for the second group subframes are allocated via explicit signaling.

At FIG. 5 the DL subframes which need feedback in the same UL subframe n are divided into 2 groups. The CCE interleaving and index in the first group is determined by the second/initial TDD configuration, while CCEs in the subframes in the second group is interleaved and indexed according to the first/flexible TDD configuration. By example, at example 5a DL subframe n-7 is in the second group and according to TDD configuration #1 the n-7 subframe should be fed back together with subframe n-6, and their CCEs should be interleaved. But since subframe n-6 is in the first group, then when it is removed when interleaving.

The first group is used to avoid collision with legacy UEs, while the conventional Release 10 CCE interleaving in the second group is reused to make the over-reserved PUCCH resource for PDCCH in some OFDM symbols adjacent to PUSCH resources.

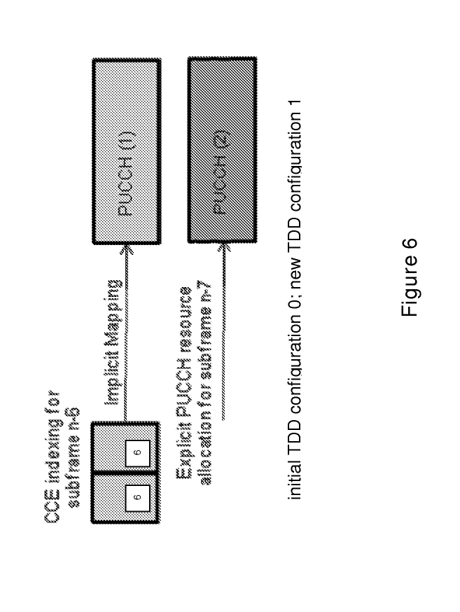

FIG. 6 illustrates PUCCH resource mapping in one example of a fourth exemplary embodiment which falls under case 2 (HARQ timing for the first UE is dependent of the UL-DL configuration which is dynamically allocated to the first UE). Like the second embodiment at FIG. 4, in this fourth embodiment at FIG. 6 there is an implicit and an explicit hybrid PUCCH allocation. For this fourth embodiment the first group of DL subframes is the same as is detailed above for the third embodiment, but for this fourth embodiment the PUCCH resources for DL subframes within the second group are communicated by the eNB via some explicit signaling.

In a first implementation of the fourth embodiment, the set of PUCCH resources associated with the DL subframes within the second group are assigned via higher layer signaling on a per UE basis. The second implementation of the second embodiment may be considered as two steps. First, multiple sets of PUCCH resources associated with the DL subframes within the second group are assigned via higher layer signaling on a per UE basis. Then the network dynamically indicates to the first/new UE which one among the sets will be used for the given UL subframe. In both implementations the first UE is left with a group of DL subframes which exclude at least some of those which map according to the second/initial UL-DL configuration since some UEs in the cell will be utilizing that configuration, but the DL subframes within the second set are adjustable by the network in this second embodiment on a per-UE basis, without having to change the second/initial configuration for the whole cell.

In the example at FIG. 6 the second/initial UL-DL configuration is 0 and the first/dynamically allocated UL-DL configuration is 1. The first group is then {n-6} and the second group is {n-7}, and the network signals the PUCCHs associated with DL subframe 7. As seen at FIG. 6 the CCEs indexed from subframe {n-6} map to one PUCCH (1) and are left available for the legacy UE to send its ACK/NACK while the CCEs indexed from subframe {n-7} map to a different PUCCH (2) for the first/new UE to send its own ACK/NACK.

The DL subframe in the first group is determined by the second/initial TDD configuration, and their CCEs are implicitly mapped to PUCCH resources, while DL subframes in the second group is determined by the first/flexible TDD configuration and their corresponding PUCCH resource is explicitly signaled.

FIGS. 4 and 6 illustrate two examples of explicit PUCCH resource allocations. Following is an example of how such explicit allocations might be signaled. Firstly, assume in total there are M1 PUCCH resources assigned for a UE implicitly, and denote the resources as set I={PUCCH_i_{—}1, PUCCH_i_{—}2, . . . , PUCCH_i_M1}. The above descriptions corresponding to FIGS. 4 and 6 summarize two ways for signaling such an explicit assignment. For the first implementation in which the set of PUCCH resources associated with the DL subframes within the second group are assigned via higher layer signaling on a per UE basis, what is signaled is the set I={PUCCH_i_{—}1, PUCCH_i_{—}2, . . . , PUCCH_i_M1}. For the second implementation in which the signaling is in two steps, for the first step the multiple sets are predefined and signaled via higher layer to a given UE. For example the sets I_{—}1, I_{—}2, . . . I_N, are signaled, where N is the number of sets. Then the UE is sent via layer 1 (L1) signaling an indication of the specific one of those multiple sets of PUCCH resources to use, such as for example two bits in a PDCCH that contains the DL grant can indicate one out of four sets of PUCCH resources.

For both case 1 and case 2, the DL subframes which need feedback in the same UL subframe n are divided into two groups. The DL subframe in the first group is determined by the second/initial TDD configuration, while the DL subframes in the second group is determined by the first TDD configuration which for case 1 (the first and second embodiments) is fixed (e.g., TDD configuration #2 or #5), and which for case 2 is the dynamically allocated TDD UL-DL configuration.

Additionally, in both case 1 and case 2, for the DL subframes in the first group the PUCCH resource is determined by implicit CCE to PUCCH mapping according to conventional mapping rules. For DL subframes in the second group the PUCCH resource can be derived based on implicit CCE to PUCCH mapping following the defined CCE indexing rule in the first and third embodiments, or the PUCCH resource can be explicitly allocated by signaling from the eNB in the second and fourth embodiments.

Exemplary embodiments of these teachings provide the technical effect of being backward compatible with legacy UEs' operation and so are simple to implement in a practical system, while further avoiding potential PUCCH resource collisions between new UEs and legacy UEs. Additionally, by maximally reusing the CCE interleaving which is now adopted in the current LTE release the implementation complexity of these embodiments is also kept low. For the first and third embodiments there is an over-reservation of PUCCH resources adjacent to a PUSCH resource to get a continuous PUSCH transmission, which minimizes wasting of radio resources. And the hybrid PUCCH resource allocation scheme detailed at the second and fourth embodiments saves the required signaling and at the same time avoids the new implementation of CCE indexing.

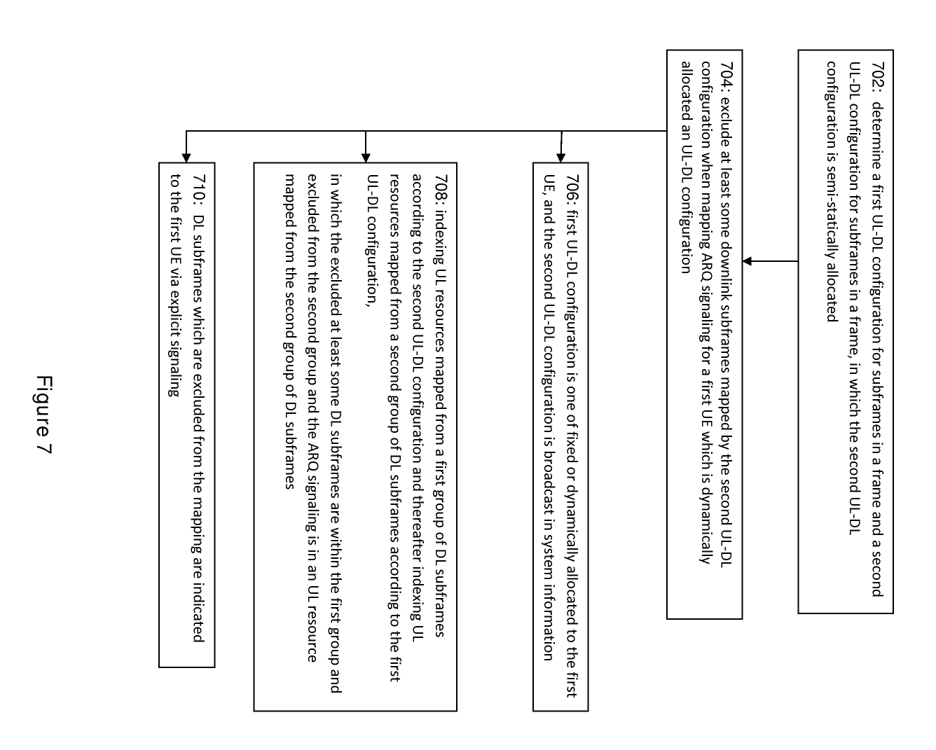

FIG. 7 is a logic flow diagram which describes an exemplary embodiment of the invention in a manner which may be from the perspective of the UE or of the eNB, since both map but in different directions. FIG. 7 may be considered to illustrate the operation of a method, and a result of execution of a computer program stored in a computer readable memory, and a specific manner in which components of an electronic device are configured to cause that electronic device to operate. The various blocks shown in FIG. 7 may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

At block 702 there is determines a first UL-DL configuration for subframes in a frame and a second UL-DL configuration for subframes in a frame, in which the second UL-DL configuration is semi-statically allocated. At block 704, at least some downlink subframes which are mapped by the second UL-DL configuration are excluded when mapping ARQ signaling for a first UE which is dynamically allocated an UL-DL configuration.

The remainder of FIG. 7 illustrate more specific implementations for blocks 702 and 704. At block 706 the first UL-DL configuration is one of fixed or dynamically allocated to the first UE, and the second UL-DL configuration is broadcast in system information. At block 708 is indexed UL resources mapped from a first group of DL subframes according to the second UL-DL configuration, and thereafter is indexed UL resources mapped from a second group of DL subframes according to the first UL-DL configuration. Further at block 708 the excluded DL subframes are within the first group and excluded from the second group, and the ARQ signaling is in an UL resource mapped from the second group of DL subframes. And at block 710 the DL subframes which are excluded from the mapping are indicated to the first UE via explicit signaling.

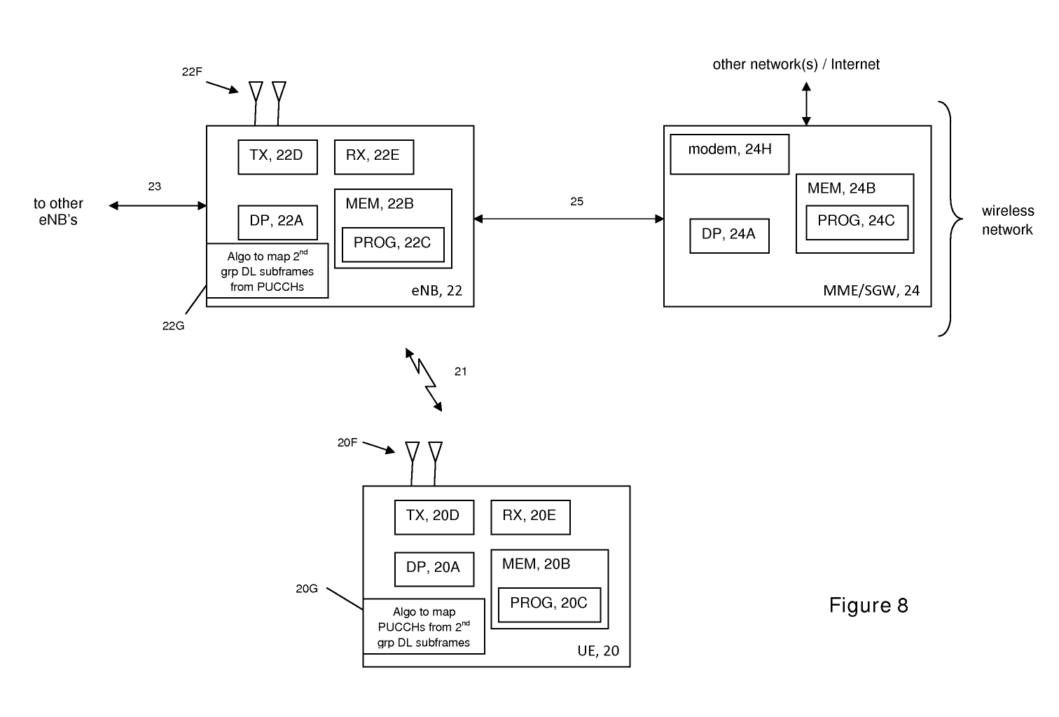

Reference is now made to FIG. 8 for illustrating a simplified block diagram of various electronic devices and apparatus that are suitable for use in practicing the exemplary embodiments of this invention. In FIG. 8 a wireless network (eNB 22 and mobility management entity MME/serving gateway SGW 24) is adapted for communication over a wireless link 21 with an apparatus, such as a mobile terminal or UE 20, via a network access node, such as a base or relay station or more specifically an eNB 22. The network may include a network control element MME/SGW 24, which provides connectivity with further networks (e.g., a publicly switched telephone network PSTN and/or a data communications network/Internet).

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the eNB 22 via one or more antennas 20F. Also stored in the MEM 20B at reference number 20G is an algorithm for mapping from the second group DL subframes to the PUCCH resources as detailed in the examples above.

The eNB 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F. There is a data and/or control path 25 coupling the eNB 22 with the MME/SGW 24, and another data and/or control path 23 coupling the eNB 22 to other eNBs/access nodes. The eNB 22 stores the algorithm 22G for mapping from the PUCCH resources on which it receives the ACK/NACK signaling to the second group DL subframes as detailed in the examples above.

Similarly, the MME/SGW 24 includes processing means such as at least one data processor (DP) 24A, storing means such as at least one computer-readable memory (MEM) 24B storing at least one computer program (PROG) 24C, and communicating means such as a modem 24H for bidirectional wireless communications with the eNB 22 via the data/control path 25. While not particularly illustrated for the UE 20 or eNB 22, those devices are also assumed to include as part of their wireless communicating means a modem which may be inbuilt on an RF front end chip within those devices 20, 22 and which also carries the TX 20D/22D and the RX 20E/22E.

At least one of the PROGs 20C in the UE 20 is assumed to include program instructions that, when executed by the associated DP 20A, enable the device to operate in accordance with the exemplary embodiments of this invention, as detailed above. The eNB 22 and MME/SGW 24 may also have software stored in their respective MEMs to implement certain aspects of these teachings. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire UE 20 or eNB 22, but exemplary embodiments may be implemented by one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 20B and 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A and 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the E-UTRAN system, it should be appreciated that the exemplary embodiments of this invention are not limited for use with only this one particular type of wireless communication system, and that they may be used to advantage in other wireless communication systems such as for example UTRAN, GERAN and GSM and others so long as there are different carriers operating on different timing which might be assigned to a UE.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

We claim:

1. An apparatus, comprising:
at least one processor; and
at least one memory storing a computer program;
in which the at least one memory with the computer program is configured with the at least one processor to cause the apparatus to at least:
determine a first uplink-downlink configuration for subframes in a frame and a second uplink-downlink configuration for subframes in a frame, in which the second uplink-downlink configuration is semi-statically allocated; and
exclude at least some downlink subframes mapped by the second uplink-downlink configuration when mapping automatic repeat request signaling for a first user equipment which is dynamically allocated an uplink-downlink configuration.

2. The apparatus according to claim 1, in which the second uplink-downlink configuration is broadcast in system information and is current for a second user equipment at a time at which the automatic repeat request signaling for the first user equipment is mapped.

3. The apparatus according to claim 2, in which mapping the automatic repeat request signaling comprises:
indexing uplink resources mapped from a first group of downlink subframes according to the second uplink-downlink configuration and thereafter indexing uplink resources mapped from a second group of downlink subframes according to the first uplink-downlink configuration, in which the excluded at least some downlink subframes are within the first group and excluded from the second group and the automatic repeat request signaling is in an uplink resource mapped from the second group of downlink subframes.

4. The apparatus according to claim 1, in which the first uplink-downlink configuration is fixed.

5. The apparatus according to claim 4, in which the first uplink-downlink configuration comprises one of uplink-downlink configuration and 5 of the table in FIG. 1.

6. The apparatus according to claim 5, in which the at least some downlink subframes which are excluded from the mapping are indicated to the first user equipment via explicit signaling.

7. The apparatus according to claim 1, in which the first uplink-downlink configuration is dynamically allocated to the first user equipment.

8. The apparatus according to claim 7, in which the at least some downlink subframes which are excluded from the mapping are indicated to the first user equipment via explicit signaling.

9. The apparatus according to claim 1, in which the apparatus comprises at least one of:
the first user equipment for which the mapping is from at least one downlink subframe to an uplink subframe, and the at least one memory with the computer program is configured with the at least one processor to cause the user equipment to transmit from at least one antenna the automatic repeat request signaling; and
a wireless network access node for which the mapping is from an uplink subframe in which the automatic repeat request signaling from the first user equipment is received to a downlink subframe in which the wireless access node transmitted via at least one antenna data to the first user equipment.

10. A method, comprising:
determining a first uplink-downlink configuration for subframes in a frame and a second uplink-downlink configuration for subframes in a frame, in which the second uplink-downlink configuration is semi-statically allocated; and
excluding at least some downlink subframes mapped by the second uplink-downlink configuration when mapping automatic repeat request signaling for a first user equipment which is dynamically allocated an uplink-downlink configuration.

11. The method according to claim 10, in which mapping the automatic repeat request signaling comprises:
indexing uplink resources mapped from a first group of downlink subframes according to the second uplink-downlink configuration and thereafter indexing uplink resources mapped from a second group of downlink subframes according to the first uplink-downlink configuration, in which the excluded at least some downlink subframes are within the first group and excluded from the second group and the automatic repeat request signaling is in an uplink resource mapped from the second group of downlink subframes.

12. The method according to claim 10, in which the first uplink-downlink configuration is fixed and the second uplink-downlink configuration is broadcast in system information.

13. The method according to claim 12, in which the first uplink-downlink configuration comprises one of uplink-downlink configuration 2 and 5 of the table in FIG. 1.

14. The method according to claim 13, in which the at least some downlink subframes which are excluded from the mapping are indicated to the first user equipment via explicit signaling.

15. The method according to claim 10, in which the first uplink-downlink configuration is dynamically allocated to the first user equipment and the second uplink-downlink configuration is broadcast in system information.

16. The method according to claim 15, in which the at least some downlink subframes which are excluded from the mapping are indicated to the first user equipment via explicit signaling.

17. The method according to claim 10, in which the method is executed by one of:
the first user equipment for which the mapping is from at least one downlink subframe to an uplink subframe, the method further comprising the user equipment transmitting the automatic repeat request signaling; and
a wireless network access node for which the mapping is from an uplink subframe in which the automatic repeat request signaling from the first user equipment is received to a downlink subframe.

18. A computer readable memory storing a computer program comprising:
code for determining a first uplink-downlink configuration for subframes in a frame and a second uplink-downlink configuration for subframes in a frame, in which the second uplink-downlink configuration is semi-statically allocated; and
code for excluding at least some downlink subframes mapped by the second uplink-downlink configuration when mapping automatic repeat request signaling for a first user equipment which is dynamically allocated an uplink-downlink configuration.

19. The computer readable memory according to claim 18, in which the code for excluding at least some downlink subframes mapped by the second uplink-downlink configuration when mapping the automatic repeat request signaling comprises:
code for indexing uplink resources mapped from a first group of downlink subframes according to the second uplink-downlink configuration and thereafter for indexing uplink resources mapped from a second group of downlink subframes according to the first uplink-downlink configuration, in which the excluded at least some downlink subframes are within the first group and excluded from the second group and the automatic repeat request signaling is in an uplink resource mapped from the second group of downlink subframes.

20. The computer readable memory according to claim 18, in which the first uplink-downlink configuration is one of fixed or dynamically allocated to the first user equipment, and the second uplink-downlink configuration is broadcast in system information.
